(19) United States
(12) Patent Application Publication
(10) Pub. No.: US 2009/0135226 A1
(43) Pub. Date: May 28, 2009

(54) INK JET PRINT HEAD AND INK JET PRINTING APPARATUS

(75) Inventors: Atsushi Sakamoto, Kawasaki-shi (JP); Ken Ikegame, Atsugi-shi (JP); Shingo Nagata, Kawasaki-shi (JP); Hidehiko Kanda, Yokohama-shi (JP); Hirokazu Tanaka, Kawasaki-shi (JP); Wakako Yamamoto, Sagamihara-shi (JP); Shigeki Fukui, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/273,138

(22) Filed: Nov. 18, 2008

(30) Foreign Application Priority Data
Nov. 27, 2007 (JP) 2007-306080

(51) Int. Cl. B41J 2/165

(52) U.S. Cl. 347/33

(57) ABSTRACT

When paper dirt that could not be removed completely by the wiping gets trapped in the recessed portions formed in the ejection port face, the paper dirt may interfere with ejection ports, giving rise to a possibility of image impairments. To deal with this problem, the ejection ports and the recessed portions in the print head are shifted from each other so that their positions are not aligned in the wiping direction.

### BACKGROUND OF THE INVENTION

1. Field of the Invention

The present invention relates to an ink jet print head that ejects ink droplets from ejection ports to print on a print medium. It also relates to an ink jet printing apparatus to perform printing using the ink jet print head.

2. Description of the Related Art

To meet a growing market demand on ink jet printing apparatus (or referred to simply as printing apparatus) for higher image quality and faster printing speed, the print head and the ink jet printing apparatus in recent years have shown significant advances in technologies for using multiple colors, increasing a density of printed dots, minimizing the size of ink droplets and forming a greater number of nozzles in the print head. When it comes to printing texts on plain paper or images on special media, the ink jet printing apparatus can form photographic images with a quality comparable to that of silver salt pictures. In using such an ink jet printing apparatus, a running cost is one of important factors that the user takes into consideration when purchasing the printing apparatus. Therefore, in addition to the advancement of performances such as high speed printing and high image quality, manufacturers of the printing apparatus have also been putting emphasis on the development of a technology that realizes high reliability of being able to always form stable images with fewer ink consumption.

In a print head with ejection ports to eject ink during a printing process, ejection of ink droplets may be blocked by viscous ink droplets adhering near the ejection port opening, dirt from a print medium (paper dust) and air-borne dust. This in turn causes ink ejection failures and ink ejection direction deviation, deteriorating a quality of printed images. To deal with such phenomena, the ink jet printing apparatus generally performs a preliminary ejection operation to discharge ink not useful for printing and a wiping operation to wipe clean the openings of ejection ports of the print head with a rubber wiping member installed in the printing apparatus body.

The surface of the print head formed with ejection ports (ejection port face) should preferably be flat and smooth in realizing better cleaning performance and efficiency during the wiping operation. The print head with a flat, smooth ejection port face can be relied upon to perform high quality printing. In designing and manufacturing the print head, the ejection port face is often formed with recessed and raised portions in addition to the ejection ports. For example, a raised portion is formed in a connecting portion between a head chip having ejection ports and wires supplying electric signals. As disclosed in Japanese Patent Laid-Open No. 2003-080717, a recessed portion is formed around ejection ports to alleviate stresses acting on the ejection port face. Further, as described in Japanese Patent Laid-Open Nos. 11-277756 (1999) and 2001-287378, there is known a technique that forms a recessed portion or groove in the ejection port face in the moving direction of the wiper member to collect ink droplets and dirt in the groove.

In print heads with a recess formed in their ejection port face, such as disclosed in Japanese Patent Laid-Open Nos. 2003-080717, 11-277756 (1999) and 2001-287378, the wiping operation may render the ink ejection unstable and cause color mixing, degrading the quality of printed images. These problems will be explained in the following.

FIG. 12A illustrates an ejection port face of a conventional print head formed with a column of ejection ports 121 and with recessed portions 122, 125 on both sides of the ejection port column to alleviate stresses acting on the ejection ports. In this ejection port face the recessed portion 125 is formed continuously. FIG. 12B shows how a wiping operation is done in this print head and a state of the ejection port face after being wiped. In the figure, a wiper 123 is moved in a direction of arrow α to clean the ejection port face. However, dirt that was removed by the wiping operation may get trapped in the recessed portions 122, 125 and remain adhering to the ejection port face after the cleaning operation. FIG. 12C shows an ejection port face of a print head having recessed portions 122 formed intermittently. A wiping operation of this print head and a state of the ejection port face after being wiped are shown in FIG. 12D. As in FIG. 12B, the wiper 123 is moved in the direction of arrow α to clean the ejection port face. However, dirt that was removed by the wiping operation may get trapped in the recessed portions 122 and remain stuck in the ejection port face after the cleaning operation. Then, as shown in FIG. 12B and FIG. 12D, once the dirt 124 trapped in the recessed portions 122, 125 during the wiping operation is caught in ejection ports, ink droplets can no longer be ejected in a desired state, giving rise to a possibility of image impairments.

When a printing apparatus has not been used for a long period of time, viscous ink remaining in a recessed portion may not be completely wiped off by the wiper 123 and may get spread from the recessed portion to be pushed into the ejection ports or cover them. At this time, if the ink color covering the ejection ports and the ink color ejected from these ejection ports differ, a color mixture may result in a printed image because both inks are ejected onto the print medium. A conventional practice to deal with this problem of color mixing is by performing a thorough preliminary ejection. In light of a growing need in recent years for reduced running cost, it is increasingly called for that the print head be wiped clean without performing the preliminary ejection as practically as possible.

### SUMMARY OF THE INVENTION

It is therefore an object of this invention to minimize possible quality degradations of printed images in an ink jet printing apparatus that uses a print head formed with recessed portions in its ejection port face.

In a first aspect of the present invention, an ink jet printing apparatus using a print head for printing, the print head having recessed portions formed in an ejection port face thereof, the ejection port face being also formed with ink ejection ports, the ink jet printing apparatus comprising:

a wiper to wipe the ejection port face in the order of the recessed portions and the ejection ports;

wherein the ejection ports and the recessed portions are arranged to be shifted from each other in a direction crossing a wiping direction of the wiper.

In a second aspect of the present invention, an ink jet printing apparatus using a print head for printing, the print head having a plurality of recessed portions formed in an ejection port face thereof, the ejection port face being also formed with an ink ejection port column having a plurality of ink ejection ports, the ink jet printing apparatus comprising:

a wiper to wipe the ejection port face in the order of the plurality of recessed portions and the ejection port column;

wherein the plurality of ejection ports in the ejection port column and the plurality of recessed portions are arranged to be shifted from each other in a direction crossing a wiping direction of the wiper.

In a third aspect of the present invention, an ink jet printing apparatus using a print head for printing, the print head having a plurality of saw-tooth-edged, recessed portions formed in an ejection port face thereof, the ejection port face being also formed with an ink ejection port column having a plurality of ink ejection ports, the ink jet printing apparatus comprising:

a wiper to wipe the ejection port face in the order of the plurality of recessed portions and the ejection port column;

wherein the plurality of ejection ports in the ejection port column and apices of the saw-tooth-edged, recessed portions are arranged to be shifted from each other in a direction crossing a wiping direction of the wiper.

In a forth aspect of the present invention, an ink jet printing apparatus using a print head for printing, the print head having a plurality of recessed portions formed in an ejection port face thereof, the ejection port face being also formed with a first and a second ejection port column each having a plurality of ink ejection ports, the ink jet printing apparatus comprising:

a wiper to wipe the ejection port face in the order of the plurality of recessed portions, the first ejection port column and the second ejection port column;

wherein the plurality of ejection ports in the first ejection port column and the plurality of recessed portions are arranged to be shifted from each other in a direction crossing a wiping direction of the wiper.

In a fifth aspect of the present invention, an ink jet print head comprising:

an ejection port face having ink ejection ports and recessed portions formed therein;

wherein the ejection port face is wiped by a wiper installed in an ink jet printing apparatus in the order of the recessed portions and the ejection ports;

wherein the ejection ports and the recessed portions are arranged to be shifted from each other in a direction crossing a wiping direction of the wiper.

In a sixth aspect of the present invention, an ink jet print head comprising:

an ejection port face having ejection port column each having a plurality of ink ejection ports and saw-tooth-edged, recessed portions formed therein;

wherein the ejection port face is wiped by a wiper installed in an ink jet printing apparatus in the order of the plurality of recessed portions and the ejection ports column;

wherein the plurality of ejection ports and apices of the recessed portions are arranged to be shifted from each other in a direction crossing a wiping direction of the wiper.

With this invention, in an ink jet printing apparatus that performs printing using a print head formed with recessed portions in its ejection port face, quality degradations of printed images can be minimized.

Further features of the present invention will become apparent from the following description of exemplary embodiments (with reference to the attached drawings).

### BRIEF DESCRIPTION OF THE DRAWINGS

FIG. 1 is a perspective view of an ink jet printing apparatus of a first embodiment, with a case cover removed to expose an internal construction;

FIG. 2 is a block diagram showing an outline configuration of a control system in the ink jet printing apparatus of the construction shown in FIG. 1;

FIG. 3A illustrates a relation between a carriage and a wiping device when the carriage moves in a forward direction in the printing apparatus of the first embodiment;

FIG. 3B shows the carriage moving in a backward direction;

FIG. 4 shows a positional relation between an ejection port column in the print head of the first embodiment and intermittently formed recessed portions provided on both sides of the ejection port column to alleviate stresses;

FIG. 5 schematically shows the ejection port face of the print head observed after it has been wiped;

FIG. 6 shows the number of dots required to eliminate color mixing and a volume of ink consumed in the conventional print head and the print head of this embodiment;

FIG. 7A shows another example of the first embodiment;

FIG. 7B shows still another example of the first embodiment;

FIG. 8 shows yet another example of the first embodiment;

FIG. 9A shows a positional relation between ejection port columns formed in an ejection port face of the print head of this embodiment and recessed portions intermittently provided on both sides of the ejection port columns to alleviate stresses;

FIG. 9B shows a positional relation between ejection port columns and recessed portions in another example;

FIG. 10A illustrates a state of the ejection port face of the conventional print head observed after a wiping operation in a comparison test;

FIG. 10B illustrates a state of the ejection port face of the print head of this embodiment observed after the wiping operation;

FIG. 10C illustrates another state of the ejection port face of the print head of this embodiment observed after the wiping operation;

FIG. 11 shows the number of dots required to eliminate color mixing and the volume of ink consumed in the conventional print head and the print head of this embodiment;

FIG. 12A shows an ejection port face of the conventional print head in which recessed portions are provided continuously;

FIG. 12B shows dirt still remaining on the ejection port face of FIG. 12A after being wiped by the wiper;

FIG. 12C shows the ejection port face of the print head formed with intermittent, recessed portions;

FIG. 12D shows how the wiping operation is performed in the print head and a state of the ejection port face after being wiped;

FIG. 13A shows an ejection port face of a print head of other embodiment; and

FIG. 13B shows an ejection port face of a print head of other embodiment.

### DESCRIPTION OF THE EMBODIMENTS

### First Embodiment

A first embodiment of this invention will be described by referring to the accompanying drawings.

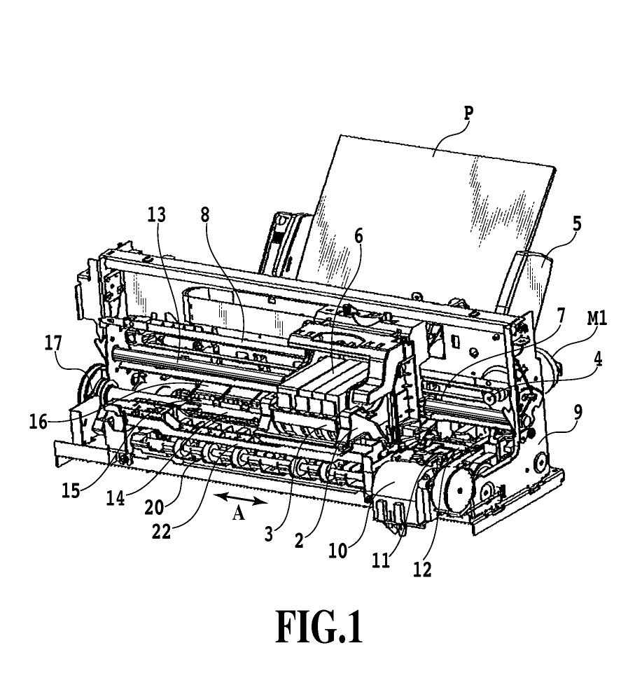

FIG. 1 is a perspective view showing an ink jet printing apparatus (also referred to simply as a printing apparatus) of this embodiment, with a case cover removed to expose the internal structure. The ink jet printing apparatus of this embodiment has a carriage 2 removably mounting an ink ejecting print head 3 and a drive mechanism to move the carriage 2 to scan the ink jet print head (also referred to simply as a print head). The carriage 2 removably mounts an ink cartridge 6 according to the kind of ink used in this printing apparatus.

The printing apparatus also has a paper supply mechanism 5 to feed a print medium P in a direction crossing the direction of movement of the carriage 2. The paper supply mechanism 5 intermittently feeds the print medium P a predetermined distance in response to the scan operation of the print head 3. Further, the ink jet printing apparatus of this embodiment has a recovery device 10 at one end of a travel range of the carriage 2 to execute an ejection performance recovery operation. In such a printing apparatus, the print medium P is supplied by the paper supply mechanism 5 into a scan area of the print head 3 where it is printed by the print head 3 to form images and characters thereon.

At a predetermined position (e.g., at a position corresponding to a home position) outside the range of a printing reciprocal motion (scan range) of the carriage 2 is installed the recovery device 10 to maintain the ejection performance of the print head 3. The recovery device 10 has a capping device 11 to cap the ejection port face of the print head 3 and a wiping device 12 to clean the ejection port face of the print head 3. The recovery device performs a recovery operation to remove, from the ejection port face of the print head 3, ink droplets, dirt coming from the print medium and air-borne dust.

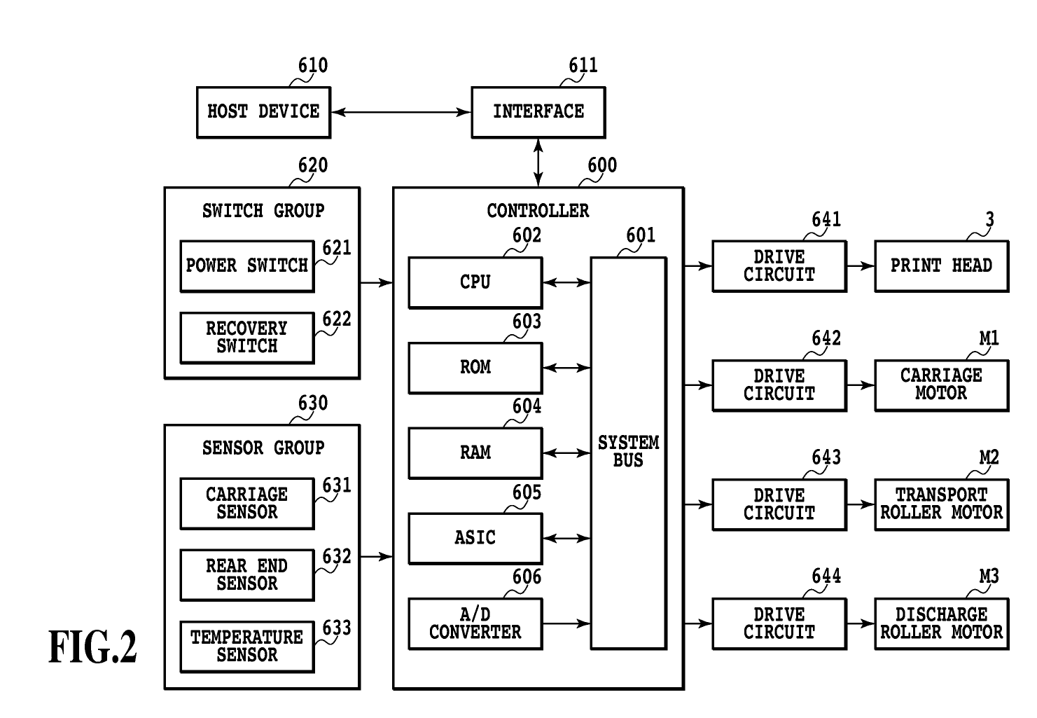

FIG. 2 is a block diagram showing an outline configuration of a control system of the ink jet printing apparatus having the construction of FIG. 1. A controller 600 controls the operation of a CPU 602 of microcomputer type and a ROM 603 and also the ejection operation of the print head 3. Further, the controller 600 also controls a carriage motor M1 and a transport roller motor 103. It also has an application specific integrated circuit (ASIC) 605 to generate control signals for a discharge roller motor 104 and a RAM 604 having an image data development area and a work area. Further, the controller 600 has an A/D converter 606 for taking in analog signals from a sensor group 630 and converting them into digital signals and a system bus 601 to transfer data to and from the CPU 602, ROM 603, RAM 604, ASIC 605 and A/D converter 606.

A host computer 610 is a print data source and transfers print data and command and status signals to and from the controller 600 through an interface (I/F) 611. A switch group 620 includes a power switch 621 and operator command switches such as a recovery switch 622 to start the recovery operation on the print head 3. A sensor group 630 has a carriage sensor 631 used in combination with a scale 8 to detect a movement of the print head 3; a rear end sensor 632 to detect a presence or absence of a print medium through a mechanical means; and a temperature sensor 633 to detect an ambient temperature.

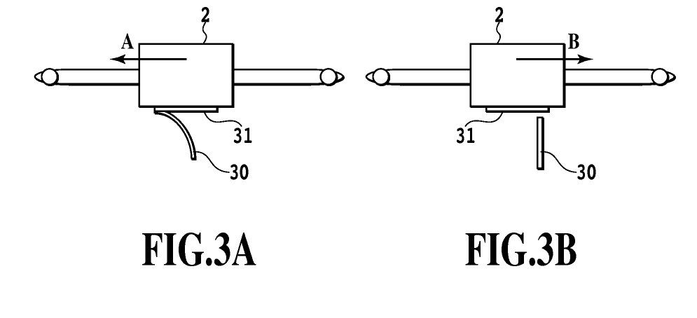

FIG. 3A shows the carriage 2 moving in a forward direction (indicated by arrow A) in the printing apparatus of this embodiment and also illustrates a relation between the carriage 2 and a wiper 30 of the wiping device 12. FIG. 3B shows the carriage 2 moving in a backward direction (indicated by arrow B). When the carriage 2 is traveling in the forward direction as shown in FIG. 3, the wiper 30 is in contact with an ejection port face 31, performing the wiping operation. When the carriage 2 is moving in the backward direction as shown in FIG. 3B, the wiper 30 is retracted to a position where it is out of contact with the ejection port face 31 of the print head.

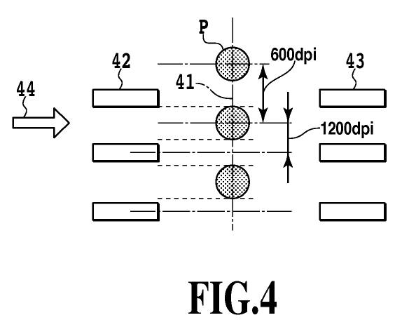

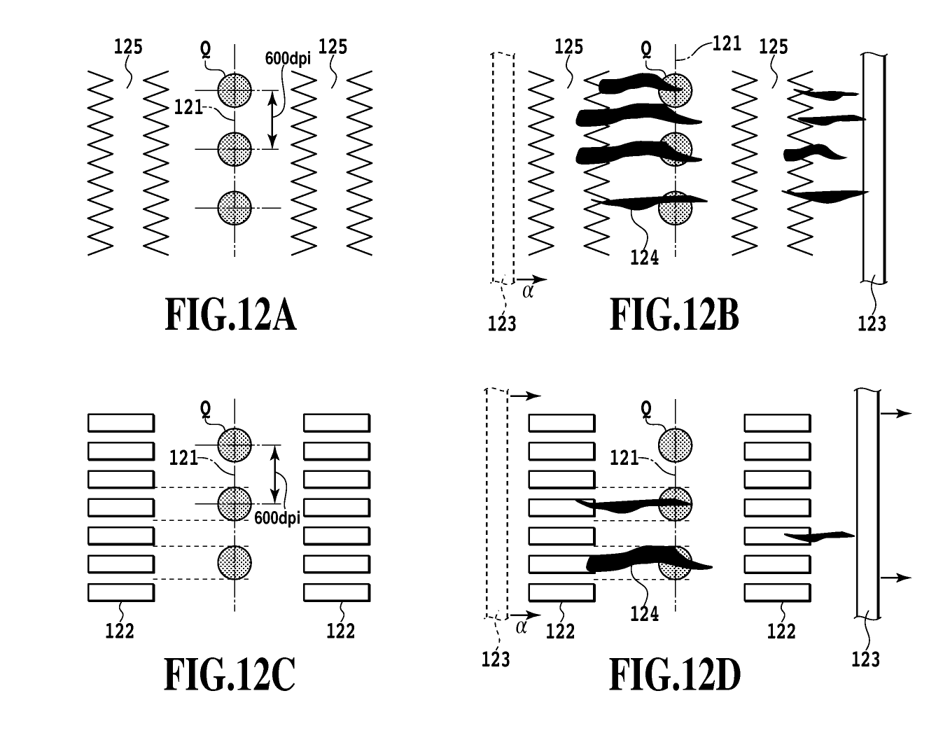

FIG. 4 illustrates a positional relation between a ejection port column 41 provided in the ejection port face 31 of the print head of this embodiment and recessed portions 43, 43 intermittently formed on both aides of the ejection port column to alleviate stresses. The print head of this embodiment has the recessed portions 42 and the ejection ports P staggered from each other in a direction crossing the wiping direction so that they do not overlap in a straight line when viewed in a scan direction of the wiper 30 (in a direction of arrow 44). In the conventional printing apparatus, the recessed portions 122 and the ejection ports Q are formed to overlap each other on a straight line (see FIG. 12C). As a result, in this conventional arrangement, dirt 124 failing to be removed by the cleaning operation is often carried by the wiper 123 and caught in the ejection ports Q formed downstream of the recessed portions 122.

To deal with this problem, this embodiment has the recessed portions 42, that the wiper passes before the ejection ports P during the wiping operation, located so that the recessed portions 42 are not aligned with the ejection ports P in the direction of wiping direction. This can reduce effects that the dirt adhering to the recessed portions 42 and unable to be removed by the wiping has on the ejection performance.

It is noted that since the wiper 30 wipes only in one direction of arrow 44, if dirt gets caught in the recessed portions 43, the ejection performance of the ejection ports P in the ejection port column 41 is not adversely affected. Therefore, if the ejection ports and the recessed portions 43 overlap each other in a straight line in the scan direction of the wiper 30, no problem arises. However, considering the ease of design and the wiping from both sides, this embodiment arranges the recessed portions 43, too, so that they are not aligned with the ejection ports P in the scan direction of the wiper 30.

To evaluate this invention in terms of the contributions it makes to improvements in quality of printed images and in terms of the effect of reducing the ink volume spent in the preliminary ejection, the following two experiments have been conducted.

(I) Experiment to Determine Performance of Removing Paper Dirt by Wiping

An accelerated test was conducted in which a certain amount of dirt (paper dirt) was scattered over the ejection port face of the print head and then wiped off, after which an observation was made of the ejection port face.

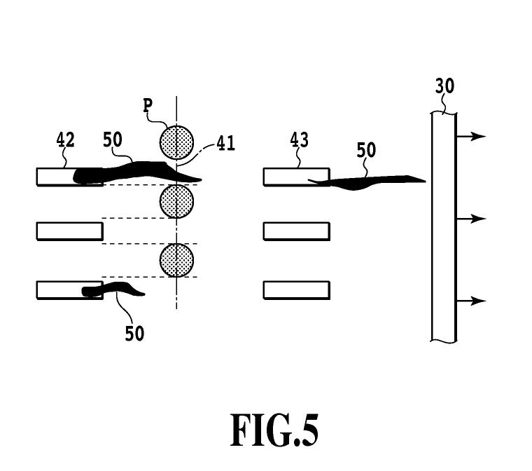

FIG. 5 schematically shows a state of the ejection port face of the print head observed following the test. It is seen that multiple pieces of paper dirt 50 that could not be removed by wiping and remain in the recessed portions 42, 43 provided on both sides of the ejection port column 41 are spread from the recessed portions 42 in the wiping direction. However, since the recessed portions 42 and the ejection ports P are not on a straight line but at staggered positions, the paper dirt 50 does not interfere with the ejection ports P. An actual printing using this print head has found that all of the ejection ports P perform normal ejections.

(II) Experiment to Determine the Number of Preliminary Ejections Required to Remove Adhering Viscous Ink Mist Following Wiping

A test was conducted in which a certain amount of viscous ink droplets was spread over the ejection port face of the print head that was then wiped without executing a preliminary ejection, after which the number of ejections in each nozzle required to eliminate color mixing was counted after the wiping operation. The smaller the count, the smaller the ink volume will be that is used for other than the printing operation.

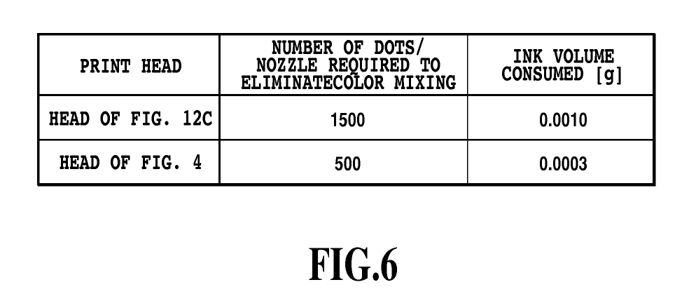

FIG. 6 shows the number of dots required to eliminate color mixing and the ink volume spent in a nozzle that showed the highest level of color mixing in the conventional print head and in the print head of this embodiment. Both of the print heads have 128 nozzles each capable of ejecting 5 pl of ink. In the conventional print head, 0.0010 g of ink was required to be ejected before the color mixing could be eliminated. With the print head of this embodiment, it took only 0.0003 g of ink to eliminate the color mixing. This shows that the print head of this embodiment can eliminate color mixing with a smaller volume of ink than the conventional print head.

As described above, by arranging the ejection ports and the recessed portions in the print head in a staggered manner so that they are not aligned in the wiping direction, it is possible to keep the ink ejection of each ejection port in good condition and to reduce the amount of ink spent in the preliminary ejections.

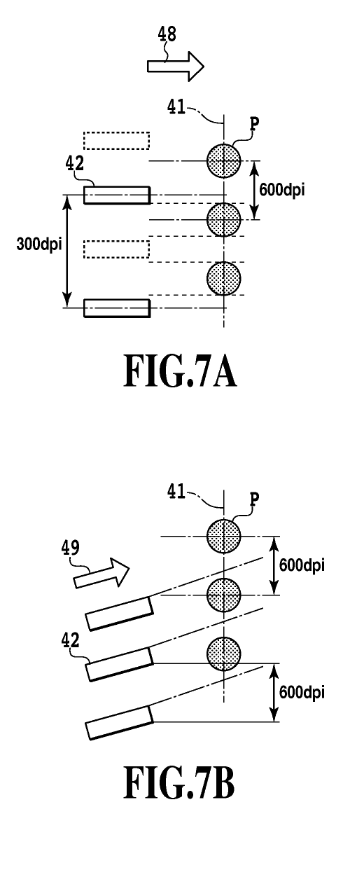

FIG. 7A represents an example in which the interval between the recessed portions 42 is set wider than 600 dpi of FIG. 4 in a range that can accomplish the purpose of alleviating stresses. FIG. 7B represents an example in which a wiping direction 49 is set at an angle with the ejection port column 41. Since both of the print heads of FIG. 7A and FIG. 7B have the recessed portions 42 and the ejection ports P arranged not in a straight line in the wiping direction 48, 49, the print quality can be improved and the ink volume spent in preliminary ejections reduced.

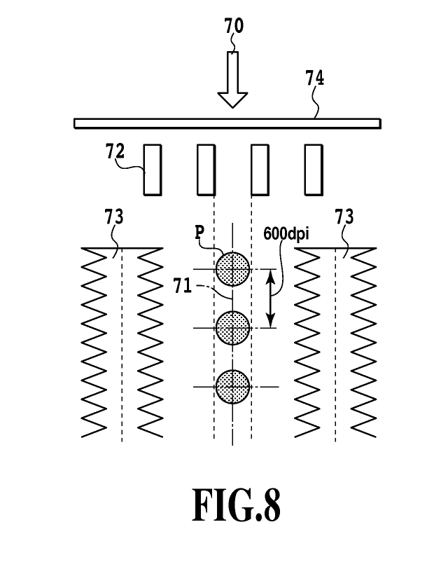

FIG. 8 represents another example which differs from those of FIG. 7A and FIG. 7B in a wiping direction 70 with respect to an ejection port column 71. In this construction, the wiping direction 70 of a wiper 74 is the same as the direction of array of the ejection ports P, which are piped in succession. In this construction too, since the recessed portions 72 and the ejection ports P are arranged so as not to be aligned with each other in the wiping direction 70, the similar effects to those of the preceding constructions can be produced.

The cleaning of the print head can be achieved also by a suction pump applying a negative pressure to ejection ports of the print head in addition to the wiping such as explained in the preceding examples. In printing apparatus having a cleaning means using the suction pump, dirt trapped in the recessed portions and ink spread by the wiper from the recessed portions can be collected by the suction recovery. However, there are printing apparatus on the market not equipped with a suction pump for reduced cost. In such printing apparatus not able to collect dirt and viscous ink by the suction recovery, the effects that the dirt and residual ink have on the degradation of ink ejection performance and the color mixing problem are profound. The above construction is particularly useful for the ink jet printing apparatus with no suction pump-based cleaning means.

### Second Embodiment

A second embodiment of this invention will be described by referring to the accompanying drawings.

A print head of this embodiment differs from the first embodiment in that two columns of ejection ports are arranged in parallel. In other respects, the print head of this embodiment is similar to the first embodiment. Thus, what has been explained in the first embodiment that is similarly applicable is omitted here.

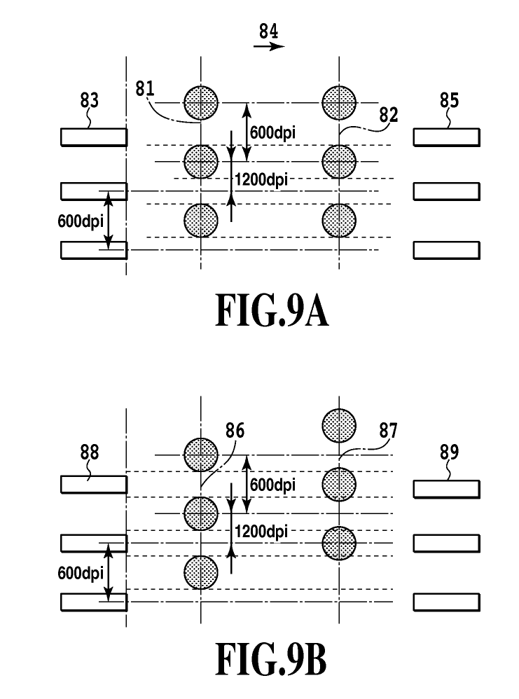

FIG. 9A illustrates a positional relation between ejection port columns 81, 82 provided in an ejection port face of the print head of this embodiment and recessed portions 83, 85 intermittently provided on both sides of the ejection port columns 81, 82 to alleviate stresses. FIG. 9B shows a positional relation between ejection port columns 86, 87 provided in an ejection port face of a print head of another example of this embodiment and recessed portions 88, 89 provided intermittently on both sides of the ejection port columns 86, 87 to reduce stresses.

In FIG. 9A, the print head of this embodiment has the recessed portions 83 disposed at positions deviated from the ejection ports by 1200 dpi or half the ejection port pitch of 600 dpi so that the recessed portions 83 are not on the same straight line as the ejection ports in the wiping direction (direction of arrow 84). As to the position of the recessed portions 85, since the scan direction of the wiper 30 is in the arrow direction 84, there is no possibility of dirt trapped in the recessed portions 85 interfering with the ejection of the ejection port columns 81, 82. Therefore, there is no problem if the ejection ports and the recessed portions 85 are aligned in the wiping direction. However, considering the ease of design and the wiping from both sides, this embodiment also arranges the recessed portions 85 so that they are not aligned with the ejection ports in the wiping direction.

Further, the print head of this embodiment shown in FIG. 9B has its ejection port columns 86, 87 staggered half-pitch from each other in a direction of array of ejection ports in order to realize a high print resolution. In the figure, the positional relation between the ejection port column 86 and the recessed portions 88, 89 is similar to that shown in FIG. 9A, whereas the ejection ports of the ejection port column 87 are arranged to overlap the recessed portions 88, 89 in a straight line in the wiping direction. However, since the ejection ports of the ejection port column 86 that the wiper first passes after having wiped the recessed portions 88 are deviated from the recessed portions 88, the similar effects can be produced even if the ejection ports of the ejection port column 87 are not deviated from the recessed portions 88.

To evaluate this invention in terms of the contributions it makes to improvements in quality of printed images and in terms of the effect of reducing the ink volume spent in the preliminary ejection, the following two experiments have been conducted.

(I) Experiment to Determine Performance of Removing Paper Dirt by Wiping

For a rough evaluation of the print head durability after a wiping operation, an accelerated test was conducted in which a certain amount of dirt (paper dirt) was scattered over an ejection port face of a print head and then wiped off, after which an observation was made of the ejection port face.

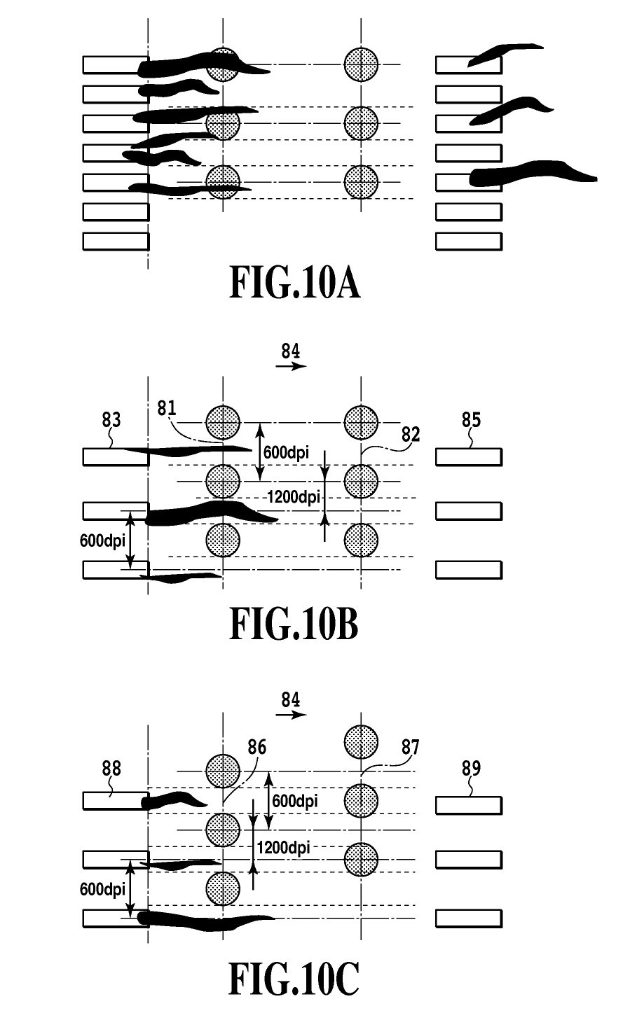

FIG. 10A shows an ejection port face of a conventional print head after being wiped in the test, which was conducted for comparison. FIG. 10B and FIG. 10C represent results of tests performed on print heads of this embodiment, with FIG. 10B and FIG. 10C corresponding to FIG. 9A and FIG. 9B respectively. In the conventional print head (FIG. 10A), paper dirt that failed to be removed by wiping can be observed to be interfering with ejection ports. In this state a normal printing cannot be done.

In the print heads of this embodiment (FIG. 10B and FIG. 10C), although paper dirt that failed to be wiped off remains adhering to the recessed portions 83 and is spread toward the ejection port column 81, it is seen to stretch only between the ejection ports of the ejection port column 81 but not interfere with the ejection ports themselves. A printing operation that was conducted using the print heads of this embodiment showed that all the ejection ports performed normal printing.

(II) Experiment to Determine the Number of Preliminary Ejections Required to Remove Adhering Viscous Ink Mist Following Wiping

A test was conducted in which a certain amount of viscous ink droplets was spread over the ejection port face of the print head that was then wiped without executing a preliminary ejection, after which the number of ejections in each nozzle required to eliminate color mixing was counted after the wiping operation. The smaller the count, the smaller the ink volume will be that is used for other than the printing operation.

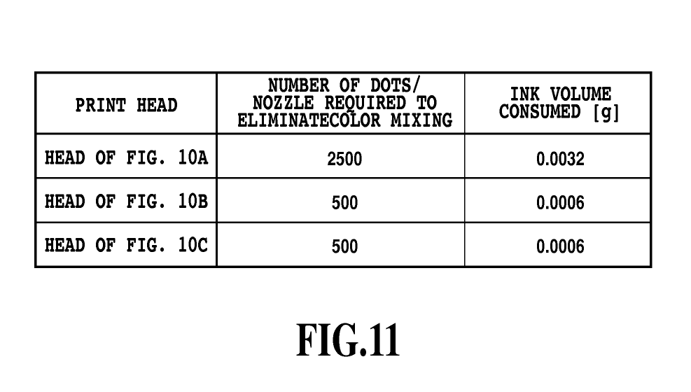

FIG. 11 shows the number of dots required to eliminate color mixing and the ink volume spent in a nozzle that showed the highest level of color mixing in the conventional print head and in the print head of this embodiment. Both of the print heads have 256 nozzles (=128×2 columns) each capable of ejecting 5 pl of ink. In the conventional print head, 0.0032 g of ink was required to be ejected before the color mixing could be eliminated. With the print head of this embodiment, it took only 0.0006 g of ink to eliminate the color mixing. This shows that the print heads of this embodiment can eliminate color mixing with a smaller volume of ink than the conventional print head.

As with the result of the (I) paper dirt removing performance test, the print head that required the largest volume of ink to eliminate color mixing was the conventional print head of FIG. 10A. The print heads of this embodiment shown in FIG. 10B and FIG. 10C could eliminate the color mixing with a smaller ink consumption. There was no significant difference between the print heads of FIG. 10B and FIG. 10C in the ink volume required to eliminate the color mixing.

The color mixing is caused by viscous ink remaining in recessed portions which fails to be removed completely by the wiper but is spread from the recessed portions to enter or cover the nozzles. That is, the color mixing is considered a result of the recessed portions adversely affecting the nozzles located downstream in the wiping direction.

As described above, by shifting the positions of the recessed portions one-half pitch from the ink ejection ports of the print head in a direction crossing the wiping direction, the ink ejection of each ejection port can be kept in good condition and the ink volume spent in preliminary ejections reduced. Particularly in a print head with multiple ejection port columns, shifting a first ejection port column, the ejection port column that the wiper first passes after wiping the recessed portions, from the recessed portions in a direction crossing the wiping direction can maintain the ink ejection of each ejection port in good condition. Further, a second ejection port column, the ejection port column that the wiper passes after wiping the first ejection port column, should preferably be shifted from the recessed portions in a direction crossing the wiping direction as this arrangement not only can keep the ink ejection of each ejection port in good condition but also is desirable in terms of the ease of design.

The print head of this embodiment is not limited to the ejection port columns ejecting the same ink colors and the same volumes of ink (same ejection port diameters) but may also be applied to the ejection port columns ejecting different ink colors or different ink volumes.

If two or more of the ejection port columns are provided in an area enclosed by the recessed portions for alleviating stresses, the similar effects can be produced as long as the positional relation between the recessed portions and the ink ejection port column situated most upstream in the wiping direction is as described above.

### Other Embodiment

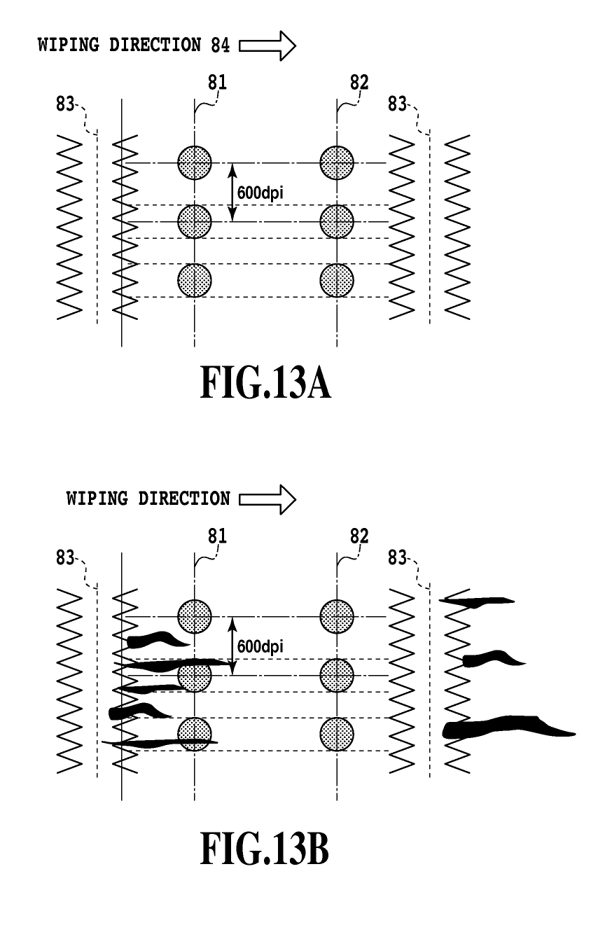

FIG. 13A and FIG. 13B show ejection port faces of a print head of other embodiment. The print head shown in FIG. 13A has formed in its ejection port face two ejection port columns 81, 82 and saw-tooth-edged, recessed portions 83 provided on both sides of the ejection port columns to alleviate stresses. FIG. 13B shows paper dirt, that could not be wiped off completely, covering or interfering with ejection ports in the ejection port face of the print head of FIG. 13A.

In the figure, the apices of saw-tooth-edged recessed portions 83 (portions closest to the ejection ports) are shifted from the ejection ports by 1200 dpi or one-half the ejection port pitch of 600 dpi so that they are not aligned in the wiping direction (direction of arrow 84). When dirt scraped by the wiper is caught in the apices, in particular, of the recessed portions 83, it often interferes with the ejection ports, giving rise to a possibility of the ejection ports not being able to eject ink droplets in a desirable state. However, shifting the apices of the recessed portions one-half pitch from the ejection ports as in the print head of FIG. 13A can reduce the effects that the dirt which could not be removed by wiping has on the ejection performance.

It is noted that the number of ejection ports in the ejection port column does not need to be equal to the number of recessed portions. These numbers may be different. Further, all the ejection ports of the ejection port columns do not have to be shifted from the recessed portions in a direction crossing the wiping direction as described above. Only a part of the ejection ports of each ejection port column may be shifted. Further, shifting the recessed portions one-half of the ejection port pitch from the ejection ports so that the recessed portions come at the center between the ejection ports can make less likely the chance of dirt in the recessed portions getting caught in the ejection ports, thus maintaining the ink ejection performance of each ejection port in good condition. It is however noted that the recessed portions do not need to be shifted one-half pitch from the ejection ports and that the amount of shift can be designed arbitrarily.

Furthermore, the direction of array of ejection ports may be the same as the wiping direction, as shown in FIG. 8 of the first embodiment, so that a plurality of ejection openings in two or more ejection port columns are wiped in succession. Such a construction, too, is of course included in the scope of this invention as long as the recessed portions and the ejection ports are arranged not to overlap in a straight line in the wiping direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-306080, filed Nov. 27, 2007, which is hereby incorporated by reference herein in its entirety.

What is claimed is:

1. An ink jet printing apparatus using a print head for printing, the print head having recessed portion formed in an ejection port face thereof, the ejection port face being also formed with ink ejection port, the ink jet printing apparatus comprising:
a wiper to wipe the ejection port face in the order of the recessed portion and the ejection port;
wherein the ejection port and the recessed portion are arranged to be shifted from each other in a direction crossing a wiping direction of the wiper.

2. An ink jet printing apparatus using a print head for printing, the print head having a plurality of recessed portions formed in an ejection port face thereof, the ejection port face being also formed with an ink ejection port column having a plurality of ink ejection ports, the ink jet printing apparatus comprising:
a wiper to wipe the ejection port face in the order of the plurality of recessed portions and the ejection port column;
wherein the plurality of ejection ports in the ejection port column and the plurality of recessed portions are arranged to be shifted from each other in a direction crossing a wiping direction of the wiper.

3. An ink jet printing apparatus according to claim 2, wherein the plurality of ejection ports and the plurality of recessed portions are arranged to be shifted from each other by half a pitch of the ejection ports in the ejection port column.

4. An ink jet printing apparatus using a print head for printing, the print head having a plurality of saw-tooth-edged, recessed portion formed in an ejection port face thereof, the ejection port face being also formed with an ink ejection port column having a plurality of ink ejection ports, the ink jet printing apparatus comprising:
a wiper to wipe the ejection port face in the order of the plurality of recessed portion and the ejection port column;
wherein the plurality of ejection ports in the ejection port column and apices of the saw-tooth-edged, recessed portion are arranged to be shifted from each other in a direction crossing a wiping direction of the wiper.

5. An ink jet printing apparatus using a print head for printing, the print head having a plurality of recessed portions formed in an ejection port face thereof, the ejection port face being also formed with a first and a second ejection port column each having a plurality of ink ejection ports, the ink jet printing apparatus comprising:
a wiper to wipe the ejection port face in the order of the plurality of recessed portions, the first ejection port column and the second ejection port column;
wherein the plurality of ejection ports in the first ejection port column and the plurality of recessed portions are arranged to be shifted from each other in a direction crossing a wiping direction of the wiper.

6. An ink jet printing apparatus according to claim 5, wherein the plurality of ejection ports in the second ejection port column and the plurality of recessed portions are arranged to be shifted from each other in the crossing direction.

7. An ink jet print head comprising:
an ejection port face having ink ejection port and recessed portion formed therein;
wherein the ejection port face is wiped by a wiper installed in an ink jet printing apparatus in the order of the recessed portion and the ejection port;
wherein the ejection port and the recessed portion are arranged to be shifted from each other in a direction crossing a wiping direction of the wiper.

8. An ink jet print head comprising:
an ejection port face having ejection port column each having a plurality of ink ejection ports and saw-tooth-edged, recessed portion formed therein;
wherein the ejection port face is wiped by a wiper installed in an ink jet printing apparatus in the order of the plurality of recessed portion and the ejection ports column;
wherein the plurality of ejection ports and apices of the recessed portion are arranged to be shifted from each other in a direction crossing a wiping direction of the wiper.
